(19) United States
(12) Patent Application Publication
(10) Pub. No.: US 2024/0027052 A1
(43) Pub. Date: Jan. 25, 2024

(54) LIGHT GUIDES CONNECTED BY FLEXIBLE LINKS

(71) Applicant: VALEO VISION, Bobigny (FR)

(72) Inventor: Olivier LELARGE, Angers (FR)

(73) Assignee: VALEO VISION, Bobigny (FR)

(21) Appl. No.: 18/257,134

(22) PCT Filed: Dec. 17, 2021
(86) PCT No.: PCT/EP2021/086376

§ 371 Date: Jun. 13, 2023

(30) Foreign Application Priority Data
Dec. 18, 2020 (FR) 20 13731

(51) Int. Cl. F21S 43/27; F21S 43/237; G02B 6/42

(52) U.S. Cl. CPC F21S 43/27; F21S 43/237; G02B 6/4239

(57) ABSTRACT

An assembly for a light device includes a plurality of optical parts made of moulded plastic material. At least one flexible link made of plastic material connects the plurality of optical parts. A method for producing a plurality of optical parts, forming the assembly noted above.

### TECHNICAL FIELD

The invention relates to the field of lighting and light signaling, in particular for motor vehicles.

### PRIOR ART

The use of light guides is now common in the field of lighting and light signaling, in particular for motor vehicles. Light guides in fact make it possible to form illuminated surfaces of elongate and potentially complex shape. They are mainly used for light signaling, in particular in motor vehicle headlights and tail lights. There may be several of them in the same device such as a headlight or tail light, in which case their mounting requires some attention, especially when they look alike despite being different.

To this end, it is known to produce a set of these different light guides in a single block, as is illustrated in FIG. 1. The assembly 2 comprises three light guides 4 which are attached to one another by a common mounting plate 6 forming a rigid link. The common mounting plate 6 may also comprise positioning and fixing means such as in particular the orifices 6.1 and 6.2. Such a construction is advantageous in that the common mounting plate 6 is made of the same material as the light guides 4 as such and is produced during the plastic injection molding of the light guides 4. However, this solution has limitations, namely essentially, on the one hand, that the shape of the light guides must allow the assembly to be demolded and, on the other hand, that this assembly, due to its relative rigidity, is fragile at the connections between the common mounting plate 6 and the light guides 4. Specifically, these connections are necessarily of limited size in order to avoid forming optical passages for light leakage.

### SUMMARY OF THE INVENTION

The aim of the invention is to mitigate at least one of the drawbacks of the abovementioned prior art. More particularly, the aim of the invention is to facilitate the assembly of a lighting device comprising several optical parts, in particular when these optical parts look alike and can be easily confused.

One subject of the invention is an assembly for a lighting device, comprising a plurality of optical parts made of molded plastics material, noteworthy in that the assembly further comprises at least one flexible link, in particular made of plastics material, connecting the plurality of optical parts. The term flexible means that the link is capable of deforming so that the optical parts can be brought closer to one another until they come into contact, without damaging the link, for example without the link breaking, and in particular in a reversible manner.

According to an advantageous embodiment of the invention, the at least one link is connected to the plurality of optical parts by adhesion with said optical parts.

According to an advantageous embodiment of the invention, the adhesion comprises polar bonds resulting from injection molding of the at least one flexible link onto the plurality of optical parts, or vice versa.

According to an advantageous embodiment of the invention, each at least one flexible link forms a wire with two ends, each attached to one of the plurality of optical parts, respectively. In the present application, the term filamentary is used to designate an element in the form of a wire.

According to an advantageous embodiment of the invention, the optical parts of the plurality of optical parts are light guides made of transparent or translucent material with a main surface providing total reflection of light.

According to an advantageous embodiment of the invention, the at least one flexible link is connected to the plurality of light guides via at least one main surface of said light guides.

According to an advantageous embodiment of the invention, at least one of the light guides of the plurality of light guides comprises a transverse protrusion comprising fixing and/or positioning means, the at least one flexible link being connected to the plurality of light guides via said at least one protrusion.

According to an advantageous embodiment of the invention, the at least one flexible link extends transversely to the light guides.

According to an advantageous embodiment of the invention, the plurality of optical parts comprise at least three of said optical parts.

Another subject of the invention is a lighting device, in particular for a motor vehicle, comprising a support; a plurality of optical parts arranged on the support; noteworthy in that the plurality of optical parts form an assembly according to the invention, the at least one flexible link of said assembly being permanently on the support.

According to an advantageous embodiment of the invention, the support comprises at least one housing permanently receiving the at least one flexible link.

According to an advantageous embodiment of the invention, the lighting device further comprises a shield arranged opposite the at least one flexible link so as to shield said at least one flexible link for an observer outside said lighting device.

Another subject of the invention is a method for manufacturing a plurality of optical parts for a lighting device, comprising the following step: injection molding of the plurality of optical parts; noteworthy in that the plurality of optical parts form an assembly according to the invention, the injection molding step comprising injection molding of the optical parts onto the at least one flexible link previously formed or placed in the mold or mold part, or injection molding of the at least one flexible link onto the optical parts previously formed by injection into the mold or mold part.

The measures of the invention are advantageous in more ways than one. Specifically, they make it possible to easily manufacture optical parts which, if they were rigidly linked together, would form an undercut preventing demolding after manufacture by plastic injection molding, while maintaining an ordering of the optical parts with respect to one another. The mounting of the assembly according to the invention on the lighting device is then simplified while having great freedom of shape for the optical parts and a controlled manufacturing cost. Also, the flexible connection between the optical parts makes it possible to bring them closer to one another during storage and transport, which is advantageous, without this connection being weakened thereby. This results in a saving of space for storage and transport and greater robustness, in particular during assembly operations.

### BRIEF DESCRIPTION OF THE DRAWINGS

FIG. 1 is a perspective view of an assembly for a lighting device, according to the prior art;

FIG. 2 represents an assembly for a lighting device, according to the invention;

FIG. 3 is a schematic representation of a mold for manufacturing an assembly for a lighting device according to the invention;

FIG. 4 is a perspective view of a motor vehicle rear light, on which the assembly for a lighting device of FIG. 2 is mounted.

### DETAILED DESCRIPTION

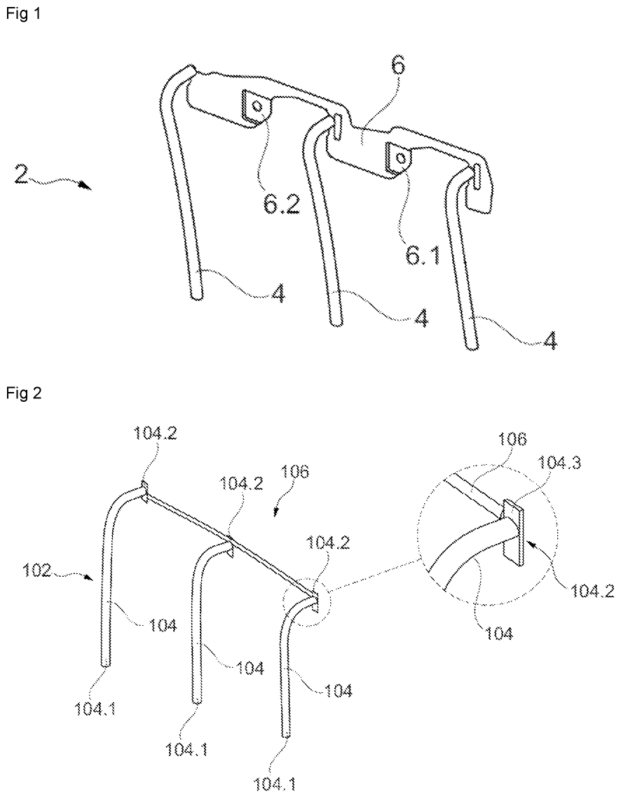

FIG. 1 is a perspective view of a set of light guides, according to the prior art and discussed in the part relating to the prior art.

FIG. 2 is a perspective view of an assembly for a lighting device, according to the invention.

The assembly 102 for the lighting device comprises several light guides 104, forming optical parts. These light guides 104 are in this case three in number, it being understood that they could be two, four or even more in number. The assembly 102 for the lighting device also comprises a flexible link 106 connecting together the optical parts, in this case the light guides 104. The flexible link 106 extends transversely to the light guides and is fixed to each of them. The connection between the flexible link 106 and the light guides is in this case by adhesion, it being understood that other modes of connection are conceivable, such as in particular by mechanical engagement.

In the case of FIG. 2, a single flexible link 106 connects three light guides 104, it being understood, however, that several flexible links may be provided, in particular a specific flexible link between each pair of light guides.

The assembly 102 for the lighting device described above is advantageous in that the flexible link(s) 106 connecting the light guides 104 ensure an ordering of the light guides with respect to one another, facilitating their mounting on the lighting device. Specifically, the light guides 104 have a great similarity while being slightly different from one another. When mounting the light guides on the lighting device, identifying the light guides is likely to slow down the manufacturing rate as well as potentially leading to assembly errors. The ordering conferred by the flexible link(s) overcomes these difficulties in that the set of light guides connected by the flexible link(s) automatically provides correct relative positioning of the light guides and avoids any loss of time in identifying the different light guides and any assembly errors. The flexible link(s) advantageously remain(s) connected to the light guides once these have been mounted on the lighting device. The flexible nature of the flexible link(s) confers a tolerance in the positioning of the light guides with respect to one another, also facilitating their assembly.

The flexible link 106 is advantageously made of flexible plastics material, in particular of thermoplastic elastomer (TPE) material. By flexible material is meant a material having both a low modulus of elasticity or Young's modulus, for example less than 1.1 GPa, preferably less than 0.1 GPa, and a large elastic deformation, typically of at least 100.

The flexible link 106 has an elongate shape of the filamentary type with a reduced cross section so as to have sufficient flexibility in bending.

Each of the light guides 104 has two ends 104.1 and 104.2. The flexible link 106 is advantageously connected to one of the ends of each of the light guides 104. The ends 104.2 of the light guides 104 to which the flexible link 106 is connected may have a transverse protrusion 104.3 forming means for positioning and/or fixing said light guides. Each of the transverse protrusions 104.3 can in particular form a mounting plate, a lug and/or a pin for positioning in a corresponding housing (not shown) formed in the lighting device. As is visible from the enlarged view of one end 104.2 of one of the light guides 104, the flexible link 106 is fixed to this transverse protrusion 104.3 so as not to be in direct contact with the total reflection guide surface of the light guide 104. It is therefore advantageous to use these means for positioning and/or fixing the light guides to make the connection there with the flexible link 106.

However, it is also conceivable for the flexible link 106 to be fixed directly to the main guide surface of the light guide.

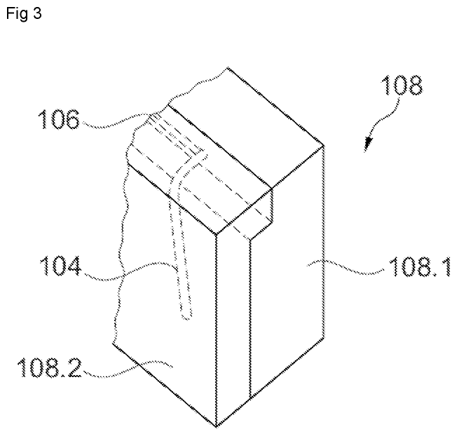

The connection of the flexible link 106 with the light guides 104 is advantageously made by adhesion. This adhesion is advantageously achieved during the manufacture of the assembly 102 for the lighting device, namely during its plastic injection molding, as will be described in relation to FIG. 3.

FIG. 3 is a schematic representation of a mold for manufacturing an assembly 102 for a lighting device according to the invention.

The plastic injection mold 108 is represented schematically and deliberately simplified. It comprises a first mold part 108.1 and a second mold part 108.2. These two mold parts 108.1 and 108.2, once arranged one against the other, form cavities corresponding to the light guides 104 and possibly to the flexible link 106. Molten plastics material, such as, for example, poly(methyl methacrylate) (PMMA) or polycarbonate (PC), is injected under pressure into the mold so as to fill the cavities corresponding to the light guides 104. Each of these cavities is formed partly by the first mold part 108.1 and partly by the second mold part 108.2 so as to allow extraction of the light guides after injection and separation of the mold parts 108.1 and 108.2.

According to a first mode of manufacture of the assembly 102 for the lighting device, the flexible link 106 is produced by injection of plastics material directly after production by plastic injection molding of the light guides 104. The flexible link 106 can be produced in the same mold as the light guides 104, subject to arrangements, such as the presence of one or more slides, making it possible to prevent the transparent plastics material of the light guides 104 from flowing into the cavity or cavities of the flexible link 106. Alternatively, the light guides 104, after injection and opening of the mold, can be transferred to another mold or mold part specifically provided for the production of the flexible link. The plastics material of the flexible link is then injected into this other mold, then allowing direct contact of this material with the material of the light guides. Given the heat prevailing in the molds, in particular the other mold, the plastics material of the flexible link will adhere to the material of the light guides by chemical cohesion. This chemical cohesion may comprise polar bonds. The assembly 102 for the lighting device thus formed can then be demolded from the other mold.

According to a second mode of manufacture of the assembly 102 for the lighting device, the flexible link 106 is manufactured by plastic injection molding first and the light guides 104 are then manufactured by plastic injection molding, in accordance with the first mode of manufacture described above, the order of plastic injection molding being, however, reversed.

The first mode has the advantage that the risks of pollution of the transparent plastics material of the light guides 104 by the, in principle non-transparent, plastics material of the flexible link 106 are reduced.

According to a third mode of manufacture of the assembly 102 for the lighting device, the flexible link 106 is prefabricated, for example cut from a longer length of such a flexible link, and placed in the injection mold 108, as illustrated in FIG. 3. In this case, it is the plastics material of the light guides 104 which is overmolded onto that of the flexible link, as in the second mode of manufacture above.

In all these modes of manufacture, the light guides 104 are manufactured by plastic injection molding and connected by chemical cohesion with the flexible link 106, thus ensuring satisfactory adhesion.

It is important to note that the flexible link 106 of the assembly 102 for the lighting device, as described above, allows the different light guides 104 to be demolded in different directions, unlike the assembly 2 for the lighting device of FIG. 1 according to the prior art. The concept of undercut in manufacturing by molding, in this case by plastic injection molding, is known and common. It may make it necessary to provide one or more slides on the manufacturing mold, in order to allow the part to be demolded. Such measures complicate the operations and increase the manufacturing cost. The flexibility of the flexible link 106 makes it possible to overcome these difficulties.

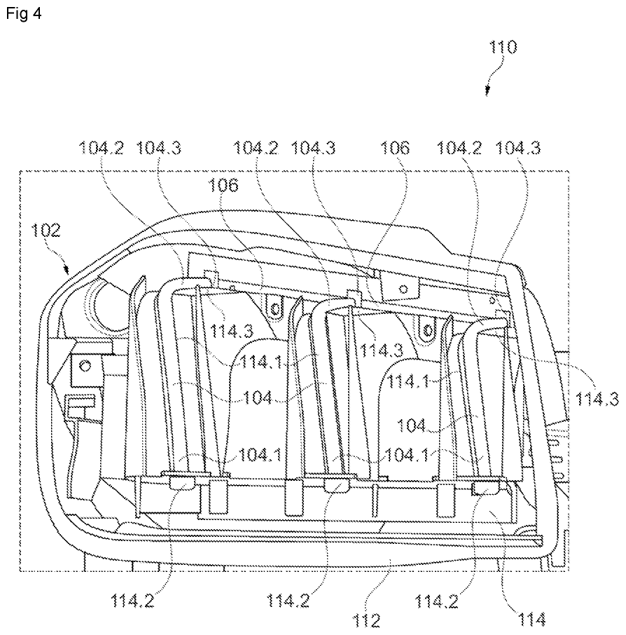

FIG. 4 is a perspective view of a motor vehicle tail light, on which the assembly for the lighting device of FIG. 2 is mounted.

The tail light 110 forms a lighting device in that it performs one or more light signaling functions, in this case one or more regulatory light signaling functions for motor vehicles.

The tail light 110 comprises a housing 112 forming a cavity, a support 114 housed in the cavity of the housing 112, and the assembly 102 for the lighting device arranged on the support 114. It should be noted that the tail light 110 comprises other elements such as light sources, an outer lens, etc., these elements being in themselves common and not relevant with regard to the present invention.

The support 114 is in this case an optical part visible by an external observer. It comprises several elongate housings 114.1, in the form of semi-circular grooves, receiving the light guides 104. It comprises first localized housings 114.2, in the form of blind holes, receiving the ends 104.1 of the light guides 104. It also comprises second localized housings 114.3, in the form of cavities, receiving the transverse protrusions 104.3 of the light guides. As can be seen in FIG. 3, the flexible link 106 is arranged on the support and remains there permanently. To this end, the support 114 may comprise cavities or housings adapted to receive the flexible link 106 in a stable manner.

The ends 104.2 of the light guides 104 each have an end face (not visible) forming a light entry face and arranged opposite a light source or an optical part capable of illuminating said entry face. The light can thus propagate by transmission along the light guides and exit therefrom in a controlled manner by means of facets or structures (not visible) distributed over the total reflection guide face of the light guides. Such facets or structures are well known per se to those skilled in the art.

In FIG. 4, the similarity between the light guides 104 is clearly visible, and at the same time, their difference in height is also clearly visible. The connection provided by the flexible link 106 makes it possible to avoid any error or hesitation in mounting the light guides 104 on the support 114.

In the specific case of the lighting device 110 of FIG. 4, the mounting of the light guides 104 consists in bringing the assembly 102 toward the support so as to present each of the light guides 104 to its housings 114.1, 114.2 and 114.3. Then, thanks to the flexible link 106, each of the light guides 104 can be mounted individually by a movement of placing the light guide in the elongate housing 114.1, in the raised position, followed by a lowering movement of the light guide so that its lower end 104.1 penetrates the first localized housing 114.2 and, at the same time, its transverse protrusion 104.3 at its upper end 104.2 engages in the second localized housing 114.3. This operation can be carried out successively for each of the light guides 104. Then, the flexible link 106 can be positioned in a corresponding housing.

A shield (not shown) can be arranged opposite the flexible link 106 in order to make it invisible to an external observer.

The description which has just been given relates to optical parts in the form of light guides. It is, however, understood that it applies to optical parts other than light guides, such as, for example, lenses, reflective surfaces, etc., or even a combination of such optical parts. Also, the invention applies to any number of optical parts, provided that it is greater than or equal to 2.

1. An assembly for a lighting device comprising:
a plurality of optical parts made of molded plastics material;
wherein the assembly further comprises:
at least one flexible link, in particular made of plastics material, connecting the plurality of optical parts.

2. The assembly as claimed in claim 1, wherein the at least one link is connected to the plurality of optical parts by adhesion with said optical parts.

3. The assembly as claimed in claim 2, wherein
the adhesion comprises polar bonds resulting from injection molding of the at least one flexible link onto the plurality of optical parts, or vice versa.

4. The assembly as claimed in claim 1, wherein each at least one flexible link forms a wire with two ends, each attached to one of the plurality of optical parts, respectively.

5. The assembly as claimed in claim 1, wherein the optical parts of the plurality of optical parts are light guides made of transparent or translucent material with a main surface providing total reflection of light.

6. The assembly as claimed in claim 5, wherein the at least one flexible link is connected to the plurality of light guides via at least one main surface of said light guides, and at least one of the light guides of the plurality of light guides comprises a transverse protrusion comprising fixing and/or positioning means, the at least one flexible link being connected to the plurality of light guides via said at least one protrusion.

7. The assembly as claimed in claim 5, wherein the at least one flexible link extends transversely to the light guides.

8. A lighting device in particular for a motor vehicle, comprising:
a support;
a plurality of optical parts arranged on the support;
wherein
the plurality of optical parts form an assembly as claimed in claim 1, the at least one flexible link of said assembly being permanently on the support.

9. The lighting device as claimed in claim 8, wherein the support comprises at least one housing permanently receiving the at least one flexible link.

10. A method for manufacturing a plurality of optical parts for a lighting device, comprising the following step:
injection molding of the plurality of optical parts;
wherein:
the plurality of optical parts form an assembly as claimed in claim 1, the injection molding step comprising injection molding of the optical parts onto the at least one flexible link previously formed or placed in the mold or mold part, or injection molding of the at least one flexible link onto the optical parts previously formed by injection into the mold or mold part.

11. The assembly as claimed in claim 2, wherein each at least one flexible link forms a wire with two ends, each attached to one of the plurality of optical parts, respectively.

12. The assembly as claimed in claim 2, wherein the optical parts of the plurality of optical parts are light guides made of transparent or translucent material with a main surface providing total reflection of light.

13. The assembly as claimed in claim 6, wherein the at least one flexible link extends transversely to the light guides.

14. A lighting device, in particular for a motor vehicle, comprising:
a support;
a plurality of optical parts arranged on the support;
wherein
the plurality of optical parts form an assembly as claimed in claim 2, the at least one flexible link of said assembly being permanently on the support.

15. A method for manufacturing a plurality of optical parts for a lighting device, comprising the following step:
injection molding of the plurality of optical parts;
wherein:
the plurality of optical parts form an assembly as claimed in claim 2, the injection molding step comprising injection molding of the optical parts onto the at least one flexible link previously formed or placed in the mold or mold part, or injection molding of the at least one flexible link onto the optical parts previously formed by injection into the mold or mold part.

16. The assembly as claimed in claim 3, wherein each at least one flexible link forms a wire with two ends, each attached to one of the plurality of optical parts, respectively.

17. The assembly as claimed in claim 3, wherein the optical parts of the plurality of optical parts are light guides made of transparent or translucent material with a main surface providing total reflection of light.

18. A lighting device, in particular for a motor vehicle, comprising:
a support;
a plurality of optical parts arranged on the support;
wherein
the plurality of optical parts form an assembly as claimed in claim 3, the at least one flexible link of said assembly being permanently on the support.

19. A method for manufacturing a plurality of optical parts for a lighting device, comprising the following step:
injection molding of the plurality of optical parts;
wherein:
the plurality of optical parts form an assembly as claimed in claim 3, the injection molding step comprising injection molding of the optical parts onto the at least one flexible link previously formed or placed in the mold or mold part, or injection molding of the at least one flexible link onto the optical parts previously formed by injection into the mold or mold part.

20. The assembly as claimed in claim 4, wherein the optical parts of the plurality of optical parts are light guides made of transparent or translucent material with a main surface providing total reflection of light.
